(19) United States
(12) Patent Application Publication
(10) Pub. No.: US 2025/0045040 A1
(43) Pub. Date: Feb. 6, 2025

(54) METHODS AND APPARATUS TO DIFFERENTIALLY UPDATE PROGRAMMABLE CIRCUITRY

(71) Applicant: Texas Instruments Incorporated, Dallas, TX (US)

(72) Inventors: Seth Rickard, Dallas, TX (US); Kristopher Ryan Burney, Garland, TX (US); Alexander D'Abreu, Dallas, TX (US); Suyash Jain, Irving, TX (US); Kumaran Vijayasankar, Allen, TX (US)

(21) Appl. No.: 18/228,462

(22) Filed: Jul. 31, 2023

(51) Int. Cl. G06F 8/654; G06F 8/658

(52) U.S. Cl. CPC G06F 8/654; G06F 8/658

(57) ABSTRACT

An example apparatus includes: interface circuitry; machine-readable instructions; and programmable circuitry configured to at least one of instantiate or execute the machine-readable instructions to: determine a number of memory sectors to shift an original image based on a length of extra data in an updated image in differential image data; shift the original image by the number of memory sectors to create a swap area, the swap area including the number of memory sectors; and construct the updated image based on the differential image data and the original image.

### TECHNICAL FIELD

This description relates generally to updating programmable circuitry and, more particularly, to methods and apparatus to differentially update programmable circuitry.

### BACKGROUND

Microprocessor circuitry is programmable circuitry configurable to execute machine-readable instructions. Microprocessor circuitry is configurable by an image stored in flash memory. The image includes a plurality of instructions that, when executed, cause the microprocessor circuitry to instantiate circuitry to perform operations.

### SUMMARY

For methods and apparatus to differentially update programmable circuitry, an example apparatus includes interface circuitry; machine-readable instructions; and programmable circuitry configured to at least one of instantiate or execute the machine-readable instructions to: determine a number of memory sectors to shift an original image based on a length of extra data in an updated image in differential image data; shift the original image by the number of memory sectors to create a swap area, the swap area including the number of memory sectors; and construct the updated image based on the differential image data and the original image.

### BRIEF DESCRIPTION OF THE DRAWINGS

FIG. 1 is a block diagram of an example update environment in which example microprocessor circuitry is to update an original image in example flash memory using example update circuitry responsive to differential image data.

FIG. 2 is a timing diagram of the flash memory of FIG. 1 during example update operations of the original image of the microprocessor circuitry of FIG. 1.

FIG. 3 is a block diagram of an example implementation of the update circuitry of FIG. 1 in which example differential update controller circuitry constructs an updated image using the differential image data.

FIG. 4 is a block diagram of an example implementation of the differential update controller circuitry of FIG. 3 to construct the updated image of FIG. 3 and replace the original image of FIG. 1 as portions of the updated image are constructed.

FIG. 5 is a timing diagram of the flash memory of FIGS. 1 and 2 during example operations to construct the updated image of FIGS. 3-4 and replace the original image of FIGS. 1 and 4 as portions of the updated image are constructed.

FIG. 6 is a flowchart representative of example machine-readable instructions and/or example operations that may be executed, instantiated, and/or performed using an example programmable circuitry implementation of the update circuitry of FIG. 3.

FIGS. 7A-7C form a flowchart representative of example machine-readable instructions and/or example operations that may be executed, instantiated, and/or performed using an example programmable circuitry implementation of the differential update controller circuitry of FIGS. 3-5 and/or more generally the update circuitry of FIG. 3.

FIG. 8 is a block diagram of an example processing platform including programmable circuitry structured to execute, instantiate, and/or perform the example machine-readable instructions and/or perform the example operations of FIGS. 6, 7A, 7B, and/or 7C to implement the update circuitry of FIG. 3.

FIG. 9 is a block diagram of an example implementation of the programmable circuitry of FIG. 8.

FIG. 10 is a block diagram of another example implementation of the programmable circuitry of FIG. 8.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

Microprocessor circuitry is programmable circuitry configurable to execute machine-readable instructions. Microprocessor circuitry is configurable by an image stored in flash memory. The image includes a plurality of instructions that, when executed, cause the microprocessor circuitry to instantiate circuitry to perform operations. As microprocessor circuitry becomes increasingly common, incentives for designers to efficiently update the image of the microprocessor circuitry continue to increase.

Designers may update an executable file, such as an image for programmable circuitry, to improve operations, add additional functionality, fix issues, etc. An updated version of a previous executable file, which includes the desired improvements and/or additions, is created external to a device that is to execute the instructions. For example, the manufacturer or supplier can generate the updated version as a software update. Once created, an updated image is supplied to the device that is to execute the instructions.

Some devices store the updated image in flash memory of the programmable circuitry. Using the flash memory to store the updated image allows the programmable circuitry to continue to store the updated image when the programmable circuitry is powered down. A process to replace an existing/original image with the updated image begins responsive to power cycling (e.g., turning off and turning on) the programmable circuitry. Such a process of replacing an existing/original image with the updated image may be referred to as an update process. Once power is restored, the programmable circuitry executes machine-readable instructions from the flash memory to instantiate circuitry to replace the original image with the updated image.

Some circuitry, instantiated to update the programmable circuitry, needs complete versions of both the original image and the updated image to be stored in flash memory in order to replace the original image with the updated image. However, as programmable circuitry becomes increasingly complex, the images continue to increase in size. In some devices, available portions of the flash memory that are used to store updated images may not be large enough to store the updated image. In such devices, designers need to add external flash to store the updated image. Alternatively, some designers have begun to look for alternative methods of storing the updated image. One alternate method includes reducing the size of the updated image.

An executable file may be reduced using a Bsdiff process to generate differential image data that represents the differences between the original image and the updated image. Bsdiff is described in “Naïve Differences of Executable Code” by Colin Percival (which is incorporated by reference in its entirety). A similar process is described in SimpleLink™ CC13x2/CC26x2 SDK TI 15.4-Stck User's Guide, available at https://software-dl.ti.com/simplelink/esd/simplelink_cc13x2_26x2_sdk/4.40.04.04/exports/docs/ti154stack/ht ml/ti154stack/oad-turbo-oad.html #turbo-oad-image-tool (which is incorporated by reference in its entirety). The Bsdiff process generates the differential image data using the original image and the updated image. The differential image data may be stored in a reduced portion of memory compared to storing the updated image. However, in resource constrained systems, such as microprocessor circuitry, replacing the updated image with the differential image data for programmable circuitry results in a need to construct the updated image during the update process. Accordingly, existing processes to update programmable circuitry need to be modified to include construction of the updated image using the differential image data.

Examples described herein include methods and apparatus to differentially update programmable circuitry using differential image data. In some described examples, update circuitry constructs an updated image using differential image data and an original image of the programmable circuitry. In such examples, the update circuitry includes differential update controller circuitry that constructs portions of the updated image in random access memory (RAM). The differential update controller circuitry prepares for an update process by shifting the original image in flash memory to create a swap area. The swap area is a plurality of memory sectors. A memory sector is a portion of the flash memory corresponding to a plurality of bits that are cleared when any of the plurality of bits are written to. The differential update controller circuitry determines the plurality of memory sectors to be used for the swap area based on the differential image data.

The differential update controller circuitry monitors the portions of the updated image in the RAM to determine when to transfer a portion of the constructed updated image. The differential update controller circuitry transfers a memory sector worth of the constructed updated image to the swap area as they are constructed. As the updated image is transferred to the swap area, the differential update controller circuitry shifts the swap area by clearing memory sectors that store portions of the original image which are no longer needed to construct remaining portions of the updated image. Advantageously, the update circuitry described herein updated the programmable circuitry using differential image data.

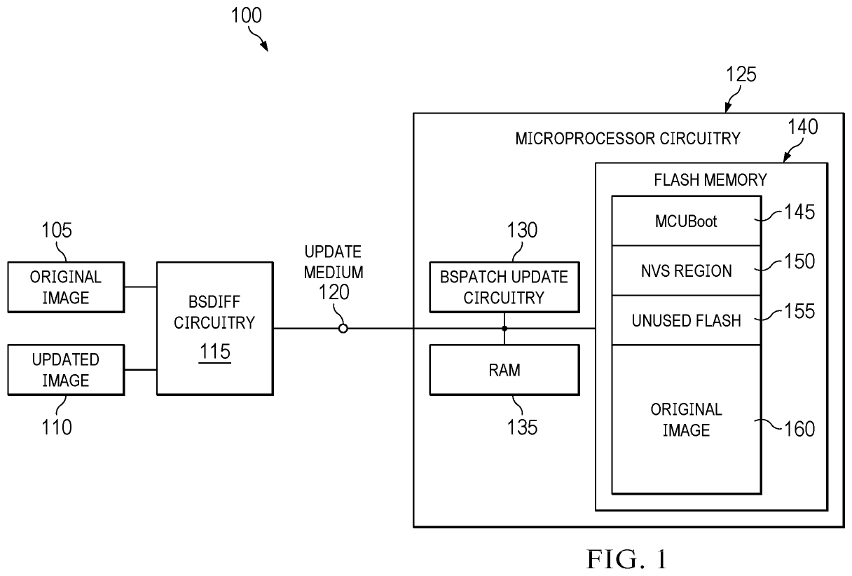

FIG. 1 is a block diagram of an example update environment 100. In the example of FIG. 1, the update environment 100 includes an example original image 105, an example updated image 110, example differential circuitry 115, an example update medium 120, and example microprocessor circuitry 125. The update environment 100 differentially updates the microprocessor circuitry 125 by replacing the original image 105 with the updated image 110. Alternatively, the environment 100 may be modified in accordance with the teachings described herein to replace and/or modify the microprocessor circuitry 125 with alternate programmable circuitry.

The images 105 and 110 are executable files that, when executed, cause the microprocessor circuitry 125 to instantiate circuitry to perform operations. The images 105 and 110 include a plurality of machine-readable instructions. The machine-readable instructions of the images 105 and 110 define the operations to be performed by the microprocessor circuitry 125. In some examples, the images 105 and 110 are binary files that include machine-readable instructions specific to a type, make, version, and/or style of programmable circuitry. For example, the original image 105 may include a plurality of sixteen-bit instructions specific to programmable circuitry configured to execute sixteen-bit instructions. In some examples, designers create a relatively higher-level abstraction of operations resulting from the execution of the images 105 and 110 using a programming language, such as assembly, C, C++, C#, etc. In such examples, designers may use a converter, a compiler, and/or a synthesis tool to obtain the images 105 and/or 110 from the relatively higher-level abstraction.

In the example of FIG. 1, the original image 105 represents an executable file stored in the microprocessor circuitry 125 prior to an update process, described herein. The original image 105 includes a plurality of machine-readable instructions that may be executed by the microprocessor circuitry 125.

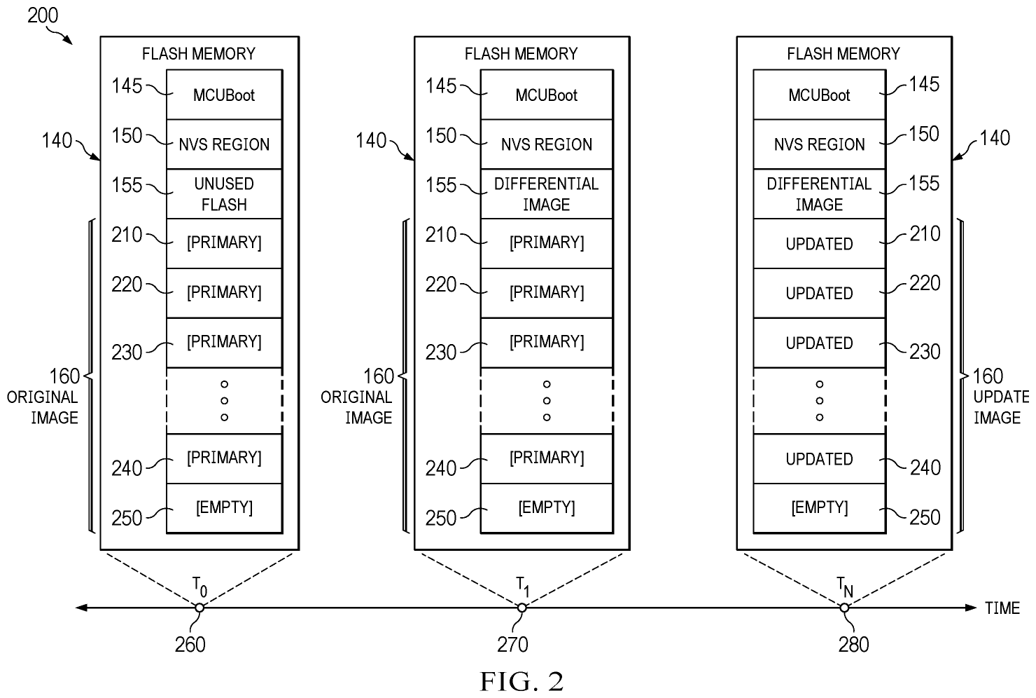

The updated image 110 represents an executable file to be stored in the microprocessor circuitry 125. In some examples, the updated image 110 is a modified version of the original image 105. For example, designers remove, add, and/or modify machine-readable instructions of the original image 105 to generate the updated image 110. The updated image 110 replaces the original image 105 in the microprocessor circuitry 125 responsive to an update process. During the update process, the microprocessor circuitry 125 replaces the original image 105 with the updated image 110. Following the update process the updated image 110 may be referred to as an original image. Such an update process is described below in connection with FIGS. 2-7C.

The differential circuitry 115 receives the images 105 and 110. In some examples, the differential circuitry 115 receives the images 105 and 110 from external circuitry, such as a converter, a compiler, a synthesis tool, etc. In other examples, the differential circuitry 115 access the images 105 and 110 based on file paths corresponding to each of the images 105 and 110, such as a location on a network, personal computer, workstation, etc. The differential circuitry 115 generates differential image data based on the images 105 and 110. The differential circuitry 115 uses the Bsdiff process, described above, to generate the differential image data. The differential circuitry 115 supplies the differential image data to the microprocessor circuitry 125 using the update medium 120. In some examples, the differential circuitry 115 writes the differential image data to a memory location in the microprocessor circuitry 125. Advantageously, the microprocessor circuitry 125 may construct the updated image 110 using the differential image data and the original image 105.

In some examples, the differential circuitry 115 includes circuitry to compress the differential image data. For example, the differential circuitry 115 compresses a number of similar bits and/or sequences of bits by creating a representation of the number of bits using fewer bits. In such an example, the differential circuitry 115 may compress one-hundred and twenty-eight sequential bits to eight bits, when the one-hundred and twenty-eight bits are of the same logic level (e.g., logical one or logical zero). Advantageously, the length of the differential image data is less than the length of the updated image 110. Advantageously, the differential circuitry 115 reduces the amount of non-volatile memory needed to update the microprocessor circuitry 125.

The update medium 120 communicatively couples the differential circuitry 115 to the microprocessor circuitry 125. The update medium 120 allows the differential circuitry 115 to communicate with the microprocessor circuitry 125 using a communication protocol (e.g., inter-integrated circuit (I2C), serial peripheral interface (SPI), etc.). In some examples, the update medium 120 is a physical medium (e.g., a connector). For example, the update medium 120 may be a connector that directly connects the differential circuitry 115 to the microprocessor circuitry 125. In other examples, the update medium 120 is a wireless medium (e.g., over the air). For example, the update medium 120 may be air, when the differential circuitry 115 and the microprocessor circuitry 125 include circuitry to communicate over the air. The update medium 120 supplies the differential image data from the differential circuitry 115 to the microprocessor circuitry 125.

The microprocessor circuitry 125 is communicatively coupled to the differential circuitry 115 by the update medium 120. In the example of FIG. 1, the microprocessor circuitry 125 includes example update circuitry 130, example RAM 135, and example flash memory 140. The microprocessor circuitry 125 is programmable circuitry configured to execute machine-readable instructions. In some examples, the microprocessor circuitry 125 includes additional and/or alternate components, such as one or more processing cores, alternate memory, etc.

The update circuitry 130 is coupled to the RAM 135 and the flash memory 140. In some examples, the update circuitry 130 is communicatively coupled to the RAM 135 and the flash memory 140 by an internal bus. In such examples, the internal bus allows the update circuitry 130 to read and/or write to the RAM 135 and/or the flash memory 140. The update circuitry 130 is adaptive to be coupled to the differential circuitry 115 by the update medium 120. The update circuitry 130 reads the differential image data and the original image 105 from the flash memory 140.

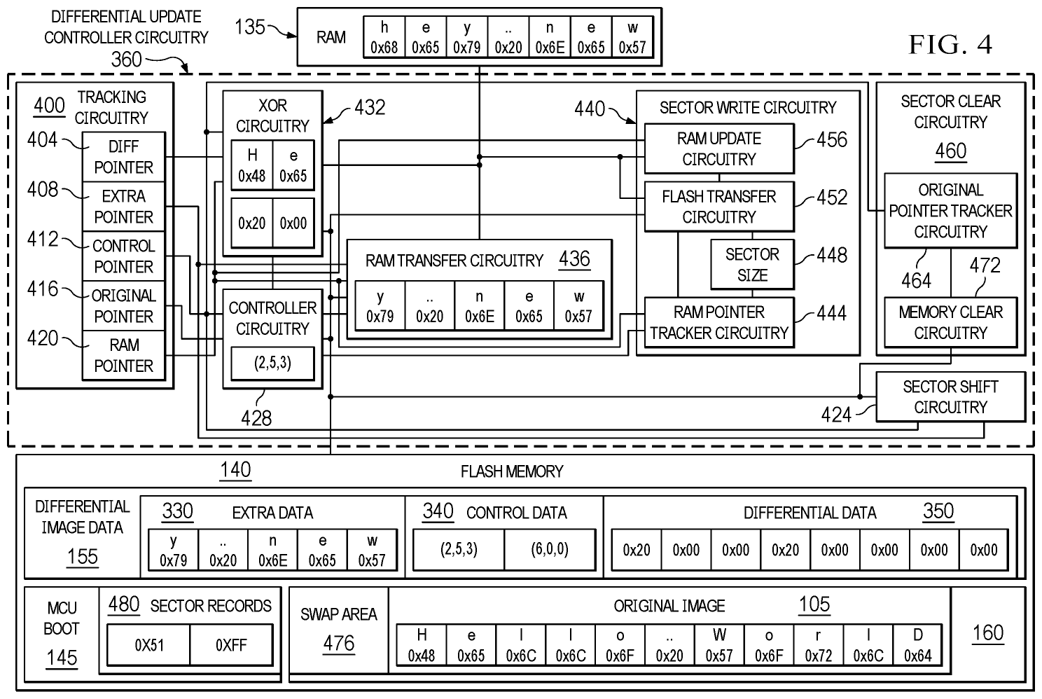

The update circuitry 130 creates a swap area (illustrated in connection with FIG. 4, below) in the flash memory 140 to store the update image 110 by shifting the original image 105. The update circuitry 130 constructs portions of the updated image 110 in the RAM 135 using the original image 105 and the differential image data. The update circuitry 130 writes the constructed portions of the updated image 110 to the swap area in the flash memory 140. The update circuitry 130 shifts the swap area by clearing portions of the original image 105. The update circuitry 130 clears a portion of the original image 105 as references to the portion of the original image 105 are no longer needed to construct the updated image 110. An example implementation of the update circuitry 130 is described in further detail in FIG. 2, below. Advantageously, the update circuitry 130 constructs the updated image 110 using the differential image data and the original image 105. Advantageously, the update circuitry 130 replaces the original image 105 as the updated image 110 is being constructed.

The RAM 135 is coupled to the update circuitry 130 and the flash memory 140. The RAM 135 is readable and writable addressable volatile memory. The RAM 135 stores data responsive to a write command. Advantageously, write commands to the RAM 135 are not limited to a specific number of bits. The update circuitry 130 constructs portions of the updated image 110 by writing bits to the RAM 135. The RAM 135 supplies data values to circuitry responsive to a read command. In some examples, the update circuitry 130 transfers a constructed portion of the updated image 110 by reading data from the RAM 135. In such examples, the update circuitry 130 writes the constructed portion of the update image 110 to the flash memory 140 to complete the transfer. Advantageously, the update circuitry 130 utilizes the RAM 135 to construct portions of the updated image 110.

The flash memory 140 is coupled to the update circuitry 130 and the RAM 135. The flash memory 140 is adaptive to be coupled to the differential circuitry 115 by the update medium 120. The flash memory 140 is readable and writable non-volatile memory. The flash memory 140 is partitioned into a plurality of sectors of memory. A sector of memory is an addressable plurality of bits. When one or more of the plurality of bits of a sector of memory are written to, all of the plurality of bits are cleared prior to writing to the one or more of the plurality of bits. The flash memory 140 stores data response to a write command. However, the flash memory 140 clears all bits of the sector of memory being written to responsive to the write command. Accordingly, the flash memory 140 may be referred to as read only memory (ROM). In some examples, the flash memory may limit write commands to instances where the data being written includes approximately a sector of memory worth of data. In such examples, the flash memory 140 stores data responsive to write commands that includes data of a length approximately equal to the length of a sector of memory to prevent data loss.

Sectors of the flash memory 140 may be partitioned to store operation specific machine-readable instructions and/or microprocessor specific data. In the example of FIG. 1, the flash memory 140 is partitioned into a first example plurality of sectors 145, a second example plurality of sectors 150, a third example plurality of sectors 155, and a fourth example plurality of sectors 160. Each of the plurality of sectors 145-160 contain a plurality of sectors of memory which may individually be read and/or written to.

In the example of FIG. 1, the first plurality of sectors 145 store machine-readable instructions specific to initializing the microprocessor circuitry 125. Programmable circuitry executes the machine-readable instructions of the first plurality of sectors 145 following power being supplied to (e.g., turning on) the microprocessor circuitry 125. Such a time may be referred to as boot or boot-up. Accordingly, the first plurality of sectors 145 may be referred to as MCUBoot sectors.

The first plurality of sectors 145 includes machine-readable instructions that, when executed, instantiate the update circuitry 130 using programmable circuitry. For example, the update circuitry 130 may be programmable circuitry executing machine-readable instructions of the first plurality of sectors 145. The machine-readable instructions of the first plurality of sectors 145 instantiate the update circuitry 130 responsive to a determination that an update process is to begin. In some examples, the machine-readable instructions of the first plurality of sectors 145 instantiate the update circuitry 130 responsive to a determination that differential image data was received and/or is stored in the flash memory 140.

In an example operation, where no update is to occur during a boot of the microprocessor circuitry 125, the first plurality of sectors 145 cause programmable circuitry to execute machine-readable instructions corresponding to the original image 105. In an example operation, where an update is to occur, such as following the differential circuitry 115 writing differential image data to the flash memory 140, instructions of the first plurality of sectors 145 cause programmable circuitry to instantiate the update circuitry 130. In such example operations, execution of the instructions of the first plurality of sectors 145 cause the update circuitry 130 to update the microprocessor circuitry 125 using the original image 105 and the differential image data. Example operations of the update circuitry 130 during an update process are described below in connection with FIGS. 2-7C.

In the example of FIG. 1, the second plurality of sectors 150 store data specific to operations of the microprocessor circuitry 125. The second plurality of sectors 150 operates as a non-volatile storage (NVS). Advantageously, data stored in the second plurality of sectors 150 remains in the flash memory 140 when power is no longer supplied to (e.g., turned off) the microprocessor circuitry 125. Accordingly, the second plurality of sectors 150 may be referred to as an NVS region. In some examples, the second plurality of sectors 150 store security information, a total uptime of the microprocessor circuitry 125, network information, etc. In other examples, the second plurality of sectors 150 stores data to provide continuity to the original image 105. For example, the second plurality of sectors 150 stores data specific to the original image 105.

The third plurality of sectors 155 correspond to available sectors of memory. In the example of FIG. 1, the third plurality of sectors 155 provides a location for the differential circuitry 115 to write the differential image data. For example, the differential circuitry 115 supplies the differential image data to the microprocessor circuitry 125 by writing the differential image data to the third plurality of sectors 155. In such examples, the microprocessor circuitry 125 may determine to update the original image 105 responsive to a detection of the differential image data in the third plurality of sectors 155. Additionally, the third plurality of sectors 155 provides additional sectors of the flash memory 140 to utilize during an update process. For example, prior to constructing portions of the updated image 110, the update circuitry 130 may expand the fourth plurality of sectors 160 by adding sectors of memory from the third plurality of sectors 155. In such an example, the update circuitry 130 uses sectors from the third plurality of sectors 155 to shift sectors of memory storing the original image 105 to add additional sectors of memory for instructions added to the updated image 110 from the original image 105.

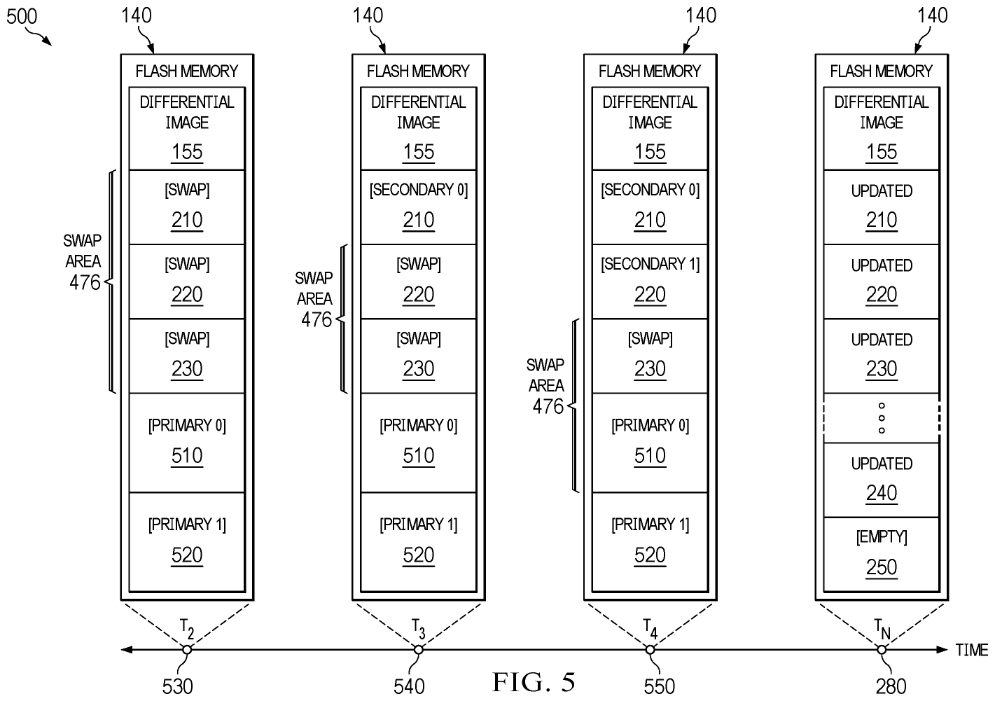

In the example of FIG. 1, the fourth plurality of sectors 160 store the original image 105. In some examples, the fourth plurality of sectors 160 may include one or more empty sectors of memory. Programmable circuitry executes the machine-readable instructions of the fourth plurality of sectors 160 following an initialization of the microprocessor circuitry 125. The update circuitry 130 updates the data stored in the fourth plurality of sectors 160 during the update process. Following the update process described below, the fourth plurality of sectors 160 store the updated image 110 (as illustrated in FIGS. 2 and 5, below).

FIG. 2 is a timing diagram of the flash memory 140 of FIG. 1 during example update operations 200 of the original image 105 of FIG. 1 of the microprocessor circuitry 125 of FIG. 1. In the example of FIG. 2, the flash memory 140 includes the first plurality of sectors 145 of FIG. 1, the second plurality of sectors 150 of FIG. 1, the third plurality of sectors 155 of FIG. 1, the fourth plurality of sectors 160 of FIG. 1, a first example memory sector 210, a second example memory sector 220, a third example memory sector 230, a fourth example memory sector 240, and a fifth example memory sector 250. The memory sectors 210-250 are writeable sections of the flash memory 140.

At a first time (T₀) 260, the flash memory 140 is configured for normal mode of operation. At the first time 260, the microprocessor circuitry 125 is turned on (e.g., power to be supplied, boot-up). Following the first time 260, the microprocessor circuitry 125 executes instructions of the first plurality of sectors 145 to initialize the microprocessor circuitry 125. After failing to detect differential image data in the third plurality of sectors 155, the microprocessor circuitry 125 proceeds with executing instructions of the fourth plurality of sectors 160. At such a time following the first time 260, the microprocessor circuitry 125 proceeds with normal operation by executing instructions of the original image 105 of FIG. 1 stored in the fourth plurality of sectors 160.

Between the first time 260 and a second time (T₁) 270, the differential circuitry 115 of FIG. 1 writes differential image data to the third plurality of sectors 155. Following the second time 270, an execution of the instructions of the first plurality of sectors 145 results in a detection of the differential image data. At such a time, the instructions of the first plurality of sectors 145 instantiate the update circuitry 130 of FIG. 1 to update the fourth plurality of sectors 160. Following the second time 270 and an instantiation of the update circuitry 130, the update circuitry 130 shifts, reads, and/or clears the memory sectors 210-250 with constructed sectors of the updated image 110 of FIG. 1.

Between the second time 270 and a third time (T_{N}) 280, the microprocessor circuitry 125 instantiates the update circuitry 130 responsive to a re-boot (e.g., powered down and powered up) of the microprocessor circuitry 125. Between the second time 270 and the third time 280, the update circuitry 130 constructs the updated image 110 based on the original image 105 of the fourth plurality of sectors 160 and the differential image data of the third plurality of sectors 155. At the third time 280, the update circuitry 130 has overwritten each of the memory sectors 210-250 with constructed sectors of the updated image 110. Following the third time 280, the update circuitry 130 may erase the third plurality of sectors 155 and begin normal operation by executing instructions of the updated image 110 in the fourth plurality of sectors 160.

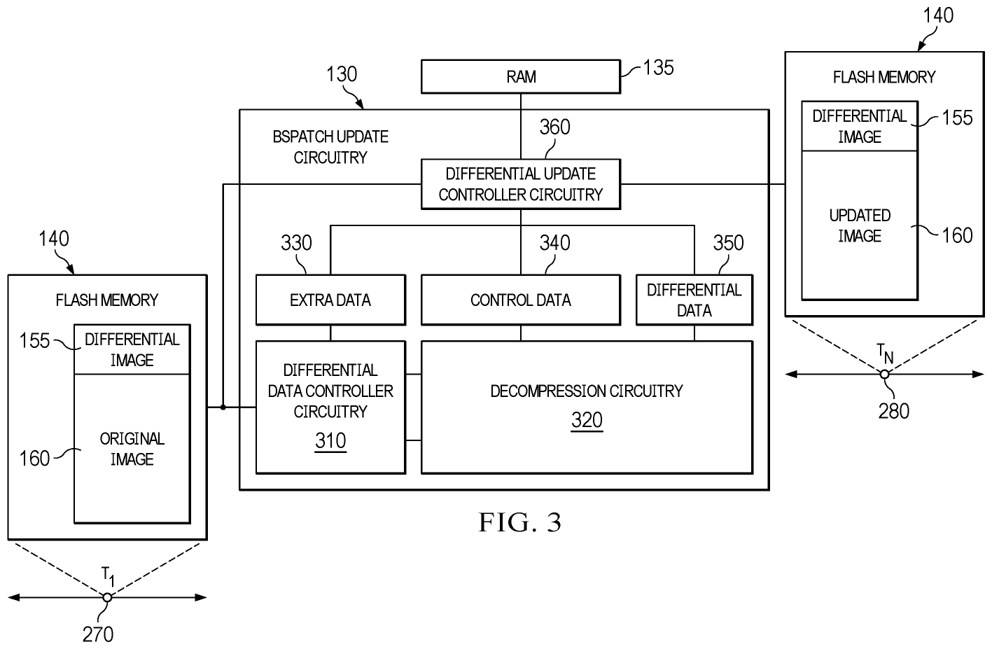

FIG. 3 is a block diagram of an example implementation of the update circuitry 130 of FIG. 1. Programmable circuitry instantiates the update circuitry 130 of FIG. 3 between the second time 270 of FIG. 2 and the third time 280 of FIG. 2 responsive to an execution of instructions of the first plurality of sectors 145. In the example of FIG. 3, the update circuitry 130 includes example differential data controller circuitry 310, example decompression circuitry 320, example extra data 330, example control data 340, example differential data 350, and example differential update controller circuitry 360. The update circuitry 130 reads the third plurality of sectors 155 of FIGS. 1 and 2 to receive the differential image data. The update circuitry 130 reads the fourth plurality of sectors 160 of FIGS. 1 and 2 to receive the original image 105 of FIG. 1. The update circuitry 130 updates the microprocessor circuitry 125 of FIG. 1.

The update circuitry 130 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the update circuitry 130 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The differential data controller circuitry 310 is coupled to the flash memory 140 of FIGS. 1 and 2, the decompression circuitry 320, and the extra data 330. The differential data controller circuitry 310 reads the third plurality of sectors 155 to receive the differential image data. In some examples, the differential data controller circuitry 310 supplies a read command to the flash memory 140. In such examples, the flash memory 140 supplies the differential image data to the differential data controller circuitry 310 responsive to the read command.

The differential data controller circuitry 310 parses the differential image data into the extra data 330, the control data 340, and the differential data 350. In some examples, the differential data controller circuitry 310 determines start memory addresses for the extra data 330, the control data 340, and the differential data 350. In such examples, the differential data controller circuitry 310 supplies the start memory address locations for the data 330-350 to the differential update controller circuitry 360.

The differential data controller circuitry 310 determines whether any of the data 330-350 is compressed. The differential data controller circuitry 310 supplies any compressed data of the data 330-350 to the decompression circuitry 320. In the example of FIG. 3, the differential data controller circuitry 310 supplies compressed versions of the control data 340 and the differential data 350 to the decompression circuitry 320.

The decompression circuitry 320 is coupled to the differential data controller circuitry 310, the control data 340, and the differential data 350. The decompression circuitry 320 decompresses the differential image data. In the example of FIG. 3, the decompression circuitry 320 decompresses the control data 340 and the differential data 350. In some examples, the decompression circuitry 320 utilizes run length decoding to decompress compressed versions of the control data 340 and the differential data 350. Advantageously, the decompression circuitry 320 allows the differential image data to include compressed data. Advantageously, the differential circuitry 115 of FIG. 1 may utilize run length encoding to compress the differential image data prior to storing the differential image data in the flash memory 140. Advantageously, the differential circuitry 115 may further reduce a size of the differential image data using compression circuitry.

In the example of FIG. 3, the differential data includes the extra data 330, the control data 340, and the differential data 350. The extra data 330 represents data to be added to the original image 105 to construct the updated image 110. For example, the extra data 330 may be one or more instructions that need to be added to the original image 105 to generate the updated image 110. The extra data 330 represents data that may not be differentially combined with data of the original image 105.

The control data 340 specifies a process for constructing the updated image 110 using the original image 105, the extra data 330, and the differential data 350. The control data 340 is a plurality of control blocks that each include first data, second data, and third data. The first data of a control block of the control data 340 specifies a first number of bytes to copy from the original image 105 and XOR with corresponding bytes of the differential data 350. The second data of a control block of the control data 340 specifies a second number of bytes to copy from the extra data 330. The third data of a control block of the control data 340 specifics a third number of bytes of the original image 105 to discard. The differential update controller circuitry 360 performs operations corresponding to the control blocks of the control data 340.

The differential data 350 represents differences between bytes of the original image 105 and the updated image 110. The differential circuitry 115 generates the differential data 350 by XORing bytes of the original image 105 with corresponding bytes of the updated image 110. In some example operations, the differential circuitry 115 XORs updates to instructions that are present in the original image 105. Advantageously, XORing bytes of the original image 105 and the differential data 350 allow the differential update controller circuitry 360 to construct the update image 110 by modifying portions of the original image 105. Advantageously, the differential data 350 allows for continuous portions of the original image 105 that are unchanged in the updated image 110 to be represented by the same logic level (e.g., logical one, logical zero). Advantageously, the continuous portions of the differential data 350 sharing the same logic level are compressible.

The differential update controller circuitry 360 accesses the original image 105 in the fourth plurality of sectors 160, the RAM 135 of FIG. 1, the extra data 330, the control data 340, and the differential data 350. The differential update controller circuitry 360 uses the original image 105 and the data 330-350 to construct the updated image 110 in the RAM 135. The differential update controller circuitry 360 transfers constructed sectors of the updated image 110 to the fourth plurality of sectors 160. In some examples, the differential update controller circuitry 360 transfers constructed portions of the updated image 110 to the fourth plurality of sectors 160 as a sector of memory of the updated image is constructed in the RAM 135. For example, the differential update controller circuitry 360 may transfer one-hundred bytes of from the RAM 135 responsive to a determination that a sector of memory is approximately equal to one-hundred bytes.

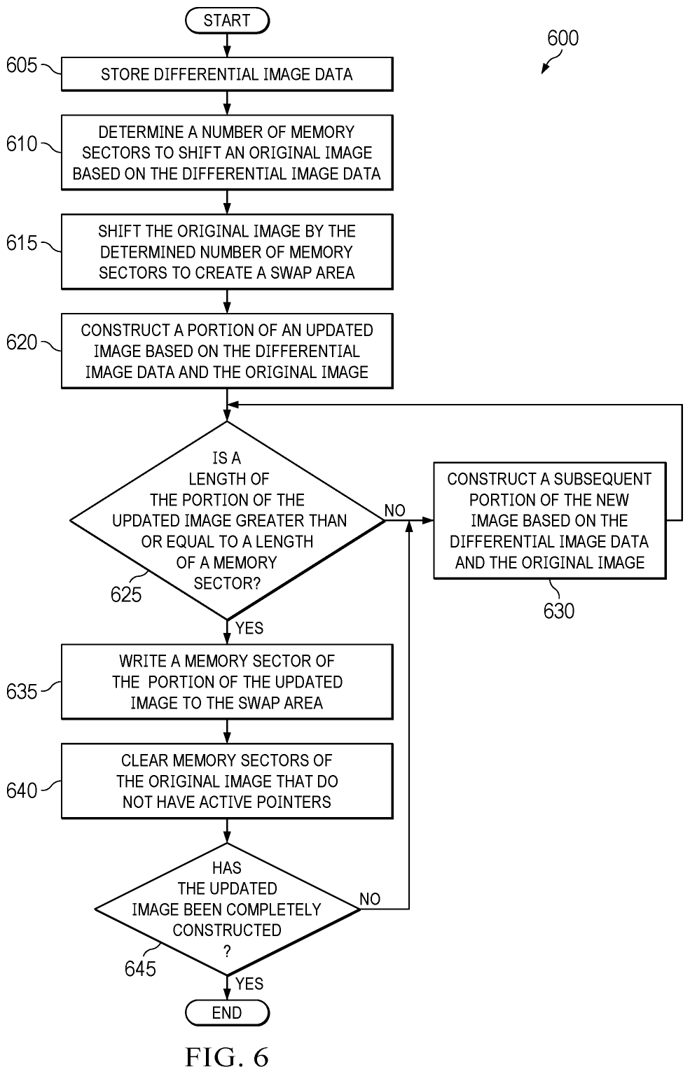

An example implementation of the differential update controller circuitry 360 is described in connection with FIGS. 4 and 5 below. Example operations implemented by the differential update controller circuitry 360 are described in connection with the flowcharts of FIGS. 6 and/or 7A-7C.

FIG. 4 is a block diagram of an example implementation of the differential update controller circuitry 360 of FIG. 3. In the example of FIG. 4, the differential update controller circuitry 360 includes example tracking circuitry 400, an example differential pointer 404, an example extra pointer 408, an example control pointer 412, an example original pointer 416, an example RAM pointer 420, example sector shift circuitry 424, example controller circuitry 428, example XOR circuitry 432, example RAM transfer circuitry 436, example sector write circuitry 440, example RAM pointer tracker circuitry 444, an example sector size 448, example flash transfer circuitry 452, example RAM update circuitry 456, example sector clear circuitry 460, example original pointer tracker circuitry 464, example length determination circuitry 468, and example memory clear circuitry 472. The differential update controller circuitry 360 is coupled to the RAM 135 of FIGS. 1 and 3 and the flash memory 140 of FIGS. 1-3. In the example of FIG. 4, the original image 105 is a string of bytes for illustrative purposes. Alternatively, the differential update controller circuitry 360 may be modified in accordance with the description herein to replace and/or modify the original image 105 to an alternate executable file.

The tracking circuitry 400 is coupled to the controller circuitry 428, the XOR circuitry 432, the RAM transfer circuitry 436, the sector write circuitry 440, and the sector clear circuitry 460. In the example of FIG. 4, the tracking circuitry 400 includes circuitry to store the pointers 404-420. In some examples, the tracking circuitry 400 may be implemented using memory, such as a plurality of registers, a portion of the RAM 135, etc.

The differential pointer 404 is a memory address of the flash memory 140 corresponding to a location of the differential data 350 of FIG. 3. The differential pointer 404 initially stores a start address of the differential data 350. For example, the differential pointer 404 initially stores a memory address corresponding to the first bit of a first byte (e.g., 0x20) of the differential data 350. The differential pointer 404 is coupled to the XOR circuitry 432. The XOR circuitry 432 increments the memory address of the differential pointer 404. For example, the XOR circuitry 432 may increment the differential pointer 404 by two bytes to cause the memory address of the differential pointer 404 to correspond to a third byte (e.g., 0x00) of the differential data 350.

The extra pointer 408 is a memory address of the flash memory 140 corresponding to a location of the extra data 330 of FIG. 3. The extra pointer 408 initially stores the start address of the extra data 330. For example, the extra pointer 408 initially stores a memory address corresponding to the first bit of a first byte (e.g., 0x79) of the extra data 330. The extra pointer 408 is coupled to the RAM transfer circuitry 436. The RAM transfer circuitry 436 increments the memory address of the extra pointer 408. For example, the RAM transfer circuitry 436 may increment the extra pointer 408 by two bytes to cause the memory address of the extra pointer 408 to correspond to a third byte (e.g., 0x6E) of the extra data 330.

The control pointer 412 is a memory address of the flash memory 140 corresponding to a location of the control data 340 of FIG. 3. The control pointer 412 initially stores the start address of the control data 340. For example, the control pointer 412 initially stores a memory address corresponding to the first bit of a first control block (e.g., (2,5,3)) of the control data 340. The control pointer 412 is coupled to the controller circuitry 428. The controller circuitry 428 increments the memory address of the control pointer 412. For example, the controller circuitry 428 may increment the control pointer 412 by one control block to cause the memory address of the control pointer 412 to correspond to a second control block (e.g., (6,0,0)) of the control data 340.

The original pointer 416 is a memory address of the flash memory 140 corresponding to a location of the original image 105 in the fourth plurality of sectors 160 of FIGS. 1-3. In some examples, the original pointer 416 initially stores the start address of the original image 105. In other examples, the original pointer 416 initially stores a shifted start address of the original image 105. For example, the original pointer 416 initially stores a memory address corresponding to the first bit of a first byte (e.g., 0x48) of the original image 105. The original pointer 416 is coupled to the sector shift circuitry 424, the controller circuitry 428, the XOR circuitry 432, and the sector clear circuitry 460. The sector shift circuitry 424, the controller circuitry 428, and/or the XOR circuitry 432 increment the memory address of the original pointer 416. For example, the controller circuitry 428 may increment the original pointer 416 by three bytes to cause the memory address of the original pointer 416 to correspond to a fourth byte (e.g., 0x6C) of the original image 105.

The RAM pointer 420 is a memory address of the RAM 135 corresponding to a location where portions of the updated image 110 are to be constructed. The RAM pointer 420 initially stores a start address in the RAM 135 of the location where portions of the updated image 110 are to be constructed. The RAM pointer 420 is coupled to the XOR circuitry 432, the RAM transfer circuitry 436, and the sector write circuitry 440, the XOR circuitry 432 and the RAM transfer circuitry 436 increment the memory address of the RAM pointer 420. The sector write circuitry 440 may decrement the RAM pointer 420 to a previous memory address.

The sector shift circuitry 424 is coupled to the flash memory 140 and the tracking circuitry 400. The sector shift circuitry 424 receives the extra pointer 408 and the original pointer 416. The sector shift circuitry 424 determines a length of the extra data 330 using the extra pointer 408. The sector shift circuitry 424 determines a number of memory sectors needed to store the extra data 330. For example, the sector shift circuitry 424 divides the length of the extra data 330 by the length of a memory sector to determine the number of memory sectors needed for the extra data 330. Alternate methods of determining the length of the extra data 330 may be used in accordance with the teachings described herein.

The sector shift circuitry 424 creates an example swap area 476 in the fourth plurality of sectors 160 by shifting the original image 105. The sector shift circuitry 424 shifts the original image 105 by the number of memory sectors needed to store the extra data 330 plus one additional sector of memory. Accordingly, the swap area 476 is a plurality of empty sectors of memory corresponding to the number of sectors of memory that the sector shift circuitry 424 shifts the original image 105. The sector shift circuitry 424 sets the original pointer 416 to correspond to the shifted location of the original image 105 in the fourth plurality of sectors 160. For example, the sector shift circuitry 424 increments the original pointer 416 by twenty-one bytes when the sector shift circuitry 424 creates the swap area 476 using twenty-one bytes.

The controller circuitry 428 is coupled to the flash memory 140, the tracking circuitry 400, the XOR circuitry 432, the RAM transfer circuitry 436, and the sector write circuitry 440. The controller circuitry 428 receives the control pointer 412 from the tracking circuitry 400. The controller circuitry 428 reads a control block from the control data 340 of the flash memory 140 based on the control pointer 412. The controller circuitry 428 determines first data, second data, and third data based on the control block from the control data 340. The controller circuitry 428 supplies the first data to the XOR circuitry 432. The controller circuitry 428 supplies the second data to the RAM transfer circuitry 436. The controller circuitry 428 increments the original pointer 416 based on the third data. The controller circuitry 428 increments the control pointer 412 to a memory address corresponding to a subsequent control block in the control data 340.

The XOR circuitry 432 is coupled to the RAM 135, the flash memory 140, the tracking circuitry 400 and the controller circuitry 428. The XOR circuitry 432 receives the differential pointer 404, the original pointer 416, and the RAM pointer 420 from the tracking circuitry 400. The XOR circuitry 432 receives the first data from the controller circuitry 428. The first data specifies a number of bytes the XOR circuitry 432 is to XOR. The XOR circuitry 432 reads the number of bytes of the original image 105 based on the first data and the original pointer 416. The XOR circuitry 432 reads the number of bytes of the differential data 350 based on the first data and the differential pointer 404. The first data specifies the number of bytes that the XOR circuitry 432 reads from the original image 105 and the differential data 350. For example, the XOR circuitry 432 reads two bytes of the original image 105 and the differential data 350 when the first data specifics two bytes.

The XOR circuitry 432 generates a portion of the updated image 110 by XORing the number of bytes of the original image 105 with the number of bytes of the differential data 350. The XOR circuitry 432 writes the portion of the updated image 110 to the RAM 135 at the memory address specified by the RAM pointer 420. The XOR circuitry 432 increments the differential pointer 404, the original pointer 416, and the RAM pointer 420 by the number of bytes specified by the first data.

The RAM transfer circuitry 436 is coupled to the RAM 135, the flash memory 140, the tracking circuitry 400, and the controller circuitry 428. The RAM transfer circuitry 436 receives the extra pointer 408 and the RAM pointer 420 from the tracking circuitry 400. The RAM transfer circuitry 436 receives the second data from the controller circuitry 428. The second data specifies a number of bytes the RAM transfer circuitry 436 is to transfer from the flash memory 140 to the RAM 135. The RAM transfer circuitry 436 transfers the number of bytes of the extra data 330 to the RAM 135 based on the extra pointer 408 and the RAM pointer 420. The extra pointer 408 specifies a memory address to begin transferring from in the extra data 330. The RAM pointer 420 specifies a memory address to transfer the portion of the extra data 330 to in the RAM 135. The RAM transfer circuitry 436 increments the extra pointer 408 and the RAM pointer 420 by the number of bytes specified by the second data. Advantageously, the RAM transfer circuitry 436 adds one or more bytes of the extra data 330 to the RAM 135.

The sector write circuitry 440 is coupled to the RAM 135, the flash memory 140, the tracking circuitry 400, and the controller circuitry 428. In the example of FIG. 4, the sector write circuitry 440 includes the RAM pointer tracker circuitry 444, the sector size 448, the flash transfer circuitry 452, and the RAM update circuitry 456. The sector write circuitry 440 monitors construction of the updated image 110 in the RAM 135. The sector write circuitry 440 writes constructed sectors of the updated image 110 to the swap area 476.

The RAM pointer tracker circuitry 444 is coupled to the tracking circuitry 400, the controller circuitry 428, the sector size 448, and the flash transfer circuitry 452. The RAM pointer tracker circuitry 444 receives the RAM pointer 420 from the tracking circuitry 400. The sector size 448 represents a size of a memory sector of the flash memory 140. The RAM pointer tracker circuitry 444 monitors incrementation of the RAM pointer 420. The RAM pointer tracker circuitry 444 determines a difference between the RAM pointer 420 and the initial value of the RAM pointer 420. The RAM pointer tracker circuitry 444 compares the difference between values of the RAM pointer 420 to the sector size 448.

The RAM pointer tracker circuitry 444 prevents the controller circuitry 428 from reading a subsequent control block responsive to a determination that the difference between values of the RAM pointer 420 is greater than the sector size 448. The RAM pointer tracker circuitry 444 supplies the initial address of the RAM pointer 420 to the flash transfer circuitry 452 responsive to a determination that the difference between values of the RAM pointer 420 is greater than the sector size 448. The RAM pointer tracker circuitry 444 allows the controller circuitry 428 to proceed with reading the subsequent control block following a determination that the difference between the values of the RAM pointer 420 is less than the sector size 448. Advantageously, the RAM pointer tracker circuitry 444 detects when the differential update controller circuitry 360 has constructed a memory sector worth of the updated image 110 in the RAM 135.

The flash transfer circuitry 452 is coupled to the RAM 135, the flash memory 140, the RAM pointer tracker circuitry 444, the sector size 448, and the RAM update circuitry 456. The flash transfer circuitry 452 receives the initial address of the RAM pointer 420 from the RAM pointer tracker circuitry 444. The flash transfer circuitry 452 reads the sector size 448 of data from the RAM 135 based on the initial address of the RAM pointer 420. The sector size 448 of data from the RAM 135 is a constructed sector of the updated image 110. The flash transfer circuitry 452 writes the sector size 448 of data from the RAM 135 to the swap area 476 of the flash memory 140. The flash transfer circuitry 452 indicates to the RAM update circuitry 456 that the sector of the update image 110 has been transferred to the flash memory 140.

The flash transfer circuitry 452 determines a sector of the fourth plurality of sectors 160 based on example sector records 480. The sector records 480 are a plurality of bytes configured to track the progress of the differential update controller circuitry 360. The sector records 480 include a record that corresponds to each of the sectors of the fourth plurality of sectors 160. For example, the sector records 480 includes one-hundred records when the fourth plurality of sectors 160 includes one-hundred records. The sector records 480 are initialized to a first value (e.g., 0xFF). The flash transfer circuitry 452 sets a record corresponding to a memory sector of the fourth plurality of sectors 160 to a second value (e.g., 0x51) responsive to writing the constructed sector of the update image 110 to the memory sector. Advantageously, the sector records 480 tracks the progress of the differential update circuitry 360 in non-volatile memory. Advantageously, the sector records 480 allow the microprocessor circuitry 125 to lose power during the update operations 200 of FIG. 2.

The RAM update circuitry 456 is coupled to the RAM 135, the tracking circuitry 400, and the flash transfer circuitry 452. The RAM update circuitry 456 receives the RAM pointer 420 from the tracking circuitry 400. The RAM update circuitry 456 receives an indication from the flash transfer circuitry 452 responsive to a transfer of a sector of the updated image 110 from the RAM 135 to the flash memory 140. The RAM update circuitry 456 shifts constructed portions of the updated image 110 that remain in the RAM 135 after the indication from the flash transfer circuitry 452 to the initial value of the RAM pointer 420. The RAM update circuitry 456 decrements the RAM pointer 420 by the sector size 448. Advantageously, the RAM pointer tracker circuitry 444 determines the RAM update circuitry 456 has decremented the RAM pointer 420 and allows the controller circuitry 428 to proceed with reading subsequent instructions.

The sector clear circuitry 460 is coupled to the flash memory 140 and the tracking circuitry 400. In the example of FIG. 4, the sector clear circuitry 460 includes the original pointer tracker circuitry 464, the length determination circuitry 468, and the memory clear circuitry 472. The sector clear circuitry 460 determines when memory sectors of the original image 105 are no longer needed. The sector clear circuitry 460 erases sectors of the original image 105 that are no longer needed by the differential update controller circuitry 360.

The original pointer tracker circuitry 464 is coupled to the tracking circuitry 400, the length determination circuitry 468, and the memory clear circuitry 472. The original pointer tracker circuitry 464 receives the original pointer 416 from the original pointer tracker circuitry 464. The original pointer tracker circuitry 464 determines whether the original pointer 416 has increased beyond a memory sector boundary. A memory sector boundary is a memory address corresponding to the start of a subsequent memory sector. The original pointer tracker circuitry 464 determines a memory address in a previous memory sector that the original pointer 416 has been incremented beyond. The original pointer tracker circuitry 464 supplies the memory address to the memory clear circuitry 472.

The memory clear circuitry 472 is coupled to the flash memory 140 and the original pointer tracker circuitry 464. The memory clear circuitry 472 receives the memory address from the original pointer tracker circuitry 464. The memory clear circuitry 472 supplies a write command to the flash memory 140 to clear the memory sector that includes the memory address from the original pointer tracker circuitry 464. Following the write command from the memory clear circuitry 472, the cleared memory sector may be considered part of the swap area 476.

In the example of FIG. 4, the differential image data of the third plurality of sectors 155 is considered to be uncompressed. In some examples, the data 330, 340, and/or 350 may be decompressed by the decompression circuitry 320 of FIG. 3. In such examples, the data 330, 340, and/or 350 may be accessible in an alternate memory location, such as in the RAM 135. Accordingly, the differential update controller circuitry 360 may be modified in accordance with the description herein to access the data 330, 340, and/or 350 in alternate memory locations. For example, one or more of the pointers 404-416 may be modified to correspond to memory addresses in the RAM 135 or alternative memory locations and/or memory types.

In an example operation, during a boot of the microprocessor circuitry 125 following the second time 270 of FIG. 2, an execution of instructions of the first plurality of sectors 145 instantiate the differential update controller circuitry 360 and sets the sector records 480 to the first value. In such an example operation, the tracking circuitry 400 initializes the pointers 404-420 memory addresses corresponding to each of the pointers 404-420. For example, the tracking circuitry 400 initializes the differential pointer 404 to a memory address corresponding to the first byte (e.g., 0x20) of the differential data 350. Following an initialization of the tracking circuitry 400, the sector shift circuitry 424 creates the swap area 476 by shifting the original image 105 based on the length of the extra data 330. The sector shift circuitry 424 increments the original pointer 416 to correspond to the shifted location of the original image 105.

In an example operation, the controller circuitry 428 reads a first control block of the control data 340 based on the control pointer 412. The first control block of the control data 340 includes the first data, the second data, and the third data. The controller circuitry 428 supplies the first data to the XOR circuitry 432 and the second data to the RAM transfer circuitry 436. The XOR circuitry 432 generates a first portion of the updated image 110 by XORing a number of bytes of the original image 105 with a number of bytes of the differential data 350 responsive to the first data. The XOR circuitry 432 writes the first portion of the updated image 110 to the RAM 135 beginning at the memory address specified by the RAM pointer 420. Advantageously, the first data allows the XOR circuitry 432 to update portions of the original image 105 to construct a portion of the updated image 110 using the differential data 350. The XOR circuitry 432 increments the pointers 404, 416, and 420 by the number of bytes specified in the first data.

Following the XOR circuitry 432 incrementing the pointers 404, 416, and/or 420, the RAM transfer circuitry 436 generates a second portion of the updated image 110 by reading a number of bytes, specified by the second data of the extra data 330. The RAM transfer circuitry 436 writes the second portion of the updated image 110 beginning at the memory address specified by the RAM pointer 420. Advantageously, the second data allows the RAM transfer circuitry 436 to construct the updated image 110 by adding portions of the extra data 330 to the RAM 135. The RAM transfer circuitry 436 increments the pointers 408 and 420 by the number of bytes specified in the second data.

Following the RAM transfer circuitry 436 incrementing the pointers 408 and/or 420, the controller circuitry 428 increments the original pointer 416 by a number of bytes specified by the third data. Advantageously, the controller circuitry 428 disregards portions of the original image 105 by incrementing the original pointer 416. Advantageously, the third data allows the controller circuitry 428 to construct the updated image 110 by disregarding portions of the original image 105. The controller circuitry 428 increments the control pointer 412 to correspond to a subsequent instruction.

Following the controller circuitry 428 incrementing the control pointer 412, the sector write circuitry 440 determines if the differential update controller circuitry 360 has constructed a memory sector of the update image 110. The RAM pointer tracker circuitry 444 prevents the controller circuitry 428 from proceeding to the subsequent control block responsive to a determination that the RAM pointer 420 indicates that a memory sector of the update image 110 is in the RAM 135. For example, the difference between an initial value of the RAM pointer 420 and the current value of the RAM pointer 420 is greater than or equal to the sector size 448.

Following the RAM pointer tracker circuitry 444 determining a portion of the updated image 110 is ready to be transferred from the RAM 135, the flash transfer circuitry 452 uses the sector records 480 to determine a location in the flash memory 140 to transfer the sector of the update image 110. In some examples, the flash transfer circuitry 452 writes the sector of the update image 110 to the memory sector corresponding to a first of the sector records 480 having the first value. The flash transfer circuitry 452 sets the record of the sector records 480 corresponding to the location of the write to a second value. Advantageously, changing the value of the sector records 480 allows update process to proceed despite the microprocessor circuitry 125 being powered down and powered up.

The RAM update circuitry 456 shifts the remaining portions of the update image 110 in the RAM 135 to the initial value of the RAM pointer 420. The RAM update circuitry 456 decrements the RAM pointer 420 by the sector size 448. In some example operations, the RAM pointer tracker circuitry 444 allows the controller circuitry 428 to proceed to the subsequent control block when the remaining data in the RAM 135 has a length less than the sector size 448. In other example operations, the RAM pointer tracker circuitry 444 may initiate another transfer from the RAM 135 responsive to the remaining data having a length greater than the sector size 448.

During such example operations, the sector clear circuitry 460 monitors the original pointer 416. The original pointer tracker circuitry 464 detects when the original pointer 416 crosses a memory sector boundary. When the original pointer 416 increases to an address in a different memory sector, the original pointer tracker circuitry 464 determines the original pointer 416 has crossed a memory sector boundary. The memory clear circuitry 472 clears memory sectors no longer needed by the differential update controller circuitry 360. Advantageously, the memory clear circuitry 472 clears memory sectors of the original image 105 as they are no longer needed.

The controller circuitry 428 proceeds with reading and parsing control blocks of the control data 340 until the updated image 110 has been fully constructed. The sector write circuitry 440 transfers the constructed portions of the updated image 110 from the RAM 135 following a final control block from the control data 340. The sector clear circuitry 460 may clear the third plurality of sectors 155 following a completion of the update process with the final control block from the control data 340. In some examples, the sector clear circuitry 460 clears the third plurality of sectors 155 following a validation of the updated image 110. Once the updated image 110 is stored in the fourth plurality of sectors 160, the microprocessor circuitry 125 may proceed with normal operations using the updated image.

FIG. 5 is a timing diagram of the flash memory 140 of FIGS. 1-4 during example update operations 500 of the microprocessor circuitry 125 of FIG. 1. In the example of FIG. 5, the flash memory 140 includes the third plurality of sectors 155 of FIGS. 1-4, the first memory sector 210 of FIG. 2, the second memory sector 220 of FIG. 2, the third memory sector 230 of FIG. 2, the fourth memory sector 240 of FIG. 2, the fifth memory sector 250 of FIG. 2, a sixth example memory sector 510, and a seventh example memory sector 520. The memory sectors 210-250, 510, and 520 are writeable portions of the fourth plurality of sectors 160 of FIGS. 1-4 in the flash memory 140. In the example of FIG. 5, the update operations 500 occur between the second time 270 of FIG. 2 and the third time 280 of FIG. 2.

Between the second time 270 and a first time (T₂) 530, the sector shift circuitry 424 shifts the original image 105 of FIGS. 1-4 creating the swap area 476 of FIG. 4. At the first time 530, the swap area 476 includes the memory sectors 210-230. At the first time 530, a start bit of the original image 105 corresponds to the sixth memory sector 510.

Between the first time 530 and a second time (T₃) 540, the differential update controller circuitry 360 of FIG. 3 constructs a first portion of the updated image 110 of FIGS. 1-4 based on the differential image data of the third plurality of sectors 155. Prior to the second time 540, the sector write circuitry 440 writes a first sector of the updated image 110 to the first memory sector 210. At the second time 540, the swap area 476 includes the memory sectors 220 and 230.

Between the second time 540 and a third time (T₄) 550, the differential update controller circuitry 360 continues to construct portions of the updated image 110 based on the differential image data of the third plurality of sectors 155. Prior to the third time 550, the sector write circuitry 440 writes a second sector of the updated image 110 to the second memory sector 220. Between the second time 540 and the third time 550, the sector clear circuitry 460 of FIG. 4 determines that the portion of the original image 105 stored in the sixth memory sector 510 is no longer needed to construct the updated image 110. Prior to the third time 550, the sector clear circuitry 460 clears the sixth memory sector 510 to shift the swap area 476. At the third time 550, the swap area 476 includes the memory sectors 230 and 510.

Between the times 550 and 280, the differential update controller circuitry 360 proceeds with constructing and transferring the updated image 110, while clearing memory sectors of the original image 105. At the third time 280, the differential update controller circuitry 360 has completed the update process of the operations 500.

FIG. 6 is a flowchart representative of example machine-readable instructions and/or example operations 600 that may be executed, instantiated, and/or performed using an example programmable circuitry implementation of the differential update controller circuitry 360 of FIGS. 1, 3, and 4, and/or more generally the update circuitry 130 of FIGS. 1 and 2 to update the microprocessor circuitry 125 of FIG. 1. The example machine-readable instructions and/or example operations 600 of FIG. 6 begin at Block 605, at which the microprocessor circuitry 125 stores differential image data in flash memory. In some examples, the differential circuitry 115 of FIG. 1 uses the update medium 120 of FIG. 1 to write differential image data to the flash memory 140 of FIGS. 1-5. In such examples, the differential circuitry 115 generates the differential image data using Bsdiff, described above, the original image 105 of FIGS. 1-5 and the updated image 110 of FIGS. 1-5.

The sector shift circuitry 424 of FIG. 4 determines a number of memory sectors to shift an original image based on the differential image data. (Block 610). In some examples, the sector shift circuitry 424 determines the number of memory sectors to shift the original image 105 based on a length of the extra data 330 of FIGS. 3 and 4. In such examples, the sector shift circuitry 424 determines the number of memory sectors needed to represent the extra data 330 plus an additional memory sector. Thus, the sector shift circuitry 424 may be configured to determine the number of memory sectors to shift the original image based on the length of the extra data 330 and further based on an additional length of memory sectors (e.g., one additional memory sector in the example of FIG. 5).

The sector shift circuitry 424 shifts the original image by the determined number of memory sectors to create a swap area. (Block 615). In some examples, the sector shift circuitry 424 creates the swap area 476 of FIG. 4 by shifting the original image 105 in the fourth plurality of sectors 160 of FIGS. 1-5. In such examples, the swap area 476 includes the determined number of memory sectors, that is the number determined in Block 610.

The controller circuitry 428 of FIG. 4, the XOR circuitry 432 of FIG. 4, and/or the RAM transfer circuitry 436 of FIG. 4 construct a portion of an updated image based on the differential image data and the original image. (Block 620). In some examples, the controller circuitry 428, the XOR circuitry 432, and/or the RAM transfer circuitry 436 construct portions of the updated image 110 in the RAM 135 of FIGS. 1, 3, and 4 based on the original image 105, the extra data 330 of FIGS. 3 and 4, the control data 340 of FIGS. 3 and 4, and the differential data 350 of FIGS. 3 and 4. In such examples, the XOR circuitry 432 and/or the RAM transfer circuitry 436 construct portions of the updated image 110 in the RAM 135 based on first and second data from the controller circuitry 426.

The sector write circuitry 440 of FIG. 4 determines if a length of the portion of the updated image is greater than or equal to a length of a memory sector. (Block 625). In some examples, sector write circuitry 440 compares the RAM pointer 420 of FIG. 4 to the initial value of the RAM pointer 420 to determine the length of a portion of the updated image 110 in the RAM 135. In such examples, the sector write circuitry 440 compares the length of the portion of the updated image 110 in the RAM 135 to the sector size 448 of FIG. 4 to determine whether the portion of the update image 110 has a length greater than the sector size 448.

If the sector write circuitry 440 determines that the length of the portion of the updated image is not greater than or equal to the length of a memory sector (e.g., Block 625 returns a result of NO), the controller circuitry 426, the XOR circuitry 432, and/or the RAM transfer circuitry 436 construct a subsequent portion of the updated image based on the differential image data and the original image. (Block 630). In some examples, the XOR circuitry 432 and/or the RAM transfer circuitry 436 construct a subsequent portion of the updated image 110 responsive to the controller circuitry 428 providing first data and second data of a subsequent control block of the control data 340. The control proceeds to return to Block 625.

If the sector write circuitry 440 determines that the length of the portion of the updated image is greater than or equal to the length of a memory sector (e.g., Block 625 returns a result of YES), the sector write circuitry 440 writes a memory sector of the portion of the updated image to the swap area. (Block 635). In some examples, the sector write circuitry 440 determines a location to write the sector of the updated image 110 based on the sector records 480 of FIG. 4. In such examples, the sector write circuitry 440 writes the sector of the updated image 110 to the flash memory 140, updates the sector records 480, and updates the remaining data in the RAM 135.

The sector clear circuitry 460 of FIG. 4 clears memory sectors of the original image that do not have active pointers. (Block 640). In some examples, the sector clear circuitry 460 detects when the original pointer 416 of FIG. 4 crosses into a subsequent memory sector of the original image 105. In such examples, the sector clear circuitry 460 clears the previous memory sector of the original image 105. Advantageously, clearing previous sectors of memory of the original image 105 shifts the swap area 476 by adding the cleared sectors to the swap area 476 and removing sectors that store portions of the updated image from the swap area 476.

The controller circuitry 428 determines if the updated image 110 has been completely constructed. (Block 645). In some examples, the controller circuitry 428 determines if the updated image 110 has been completely constructed based on the control data 340. In such examples, the controller circuitry 428 determines the updated image 110 has been completely constructed based on a determination that all control blocks of the control data 340 have been implemented. In other examples, the controller circuitry determines the updated image 110 has been completely constructed based on a determination that the control pointer 412 identifies a memory address outside of the control data 340.

If the controller circuitry 428 determines that the updated image has not been completely constructed (e.g., Block 645 returns a result of NO), the control proceeds to return to Block 630. If the controller circuitry 428 determines that the updated image has been completely constructed (e.g., Block 645 returns a result of YES), the control proceeds to end.

Although example processes are described with reference to the flowchart illustrated in FIG. 6, many other methods of updating microprocessor circuitry using differential image data may alternatively be used in accordance with teachings of this disclosure. For example, the order of execution of the blocks may be changed, and/or some of the blocks described may be changed, eliminated, or combined. Similarly, additional operations may be included in the manufacturing process before, in between, or after the blocks shown in the illustrated examples.

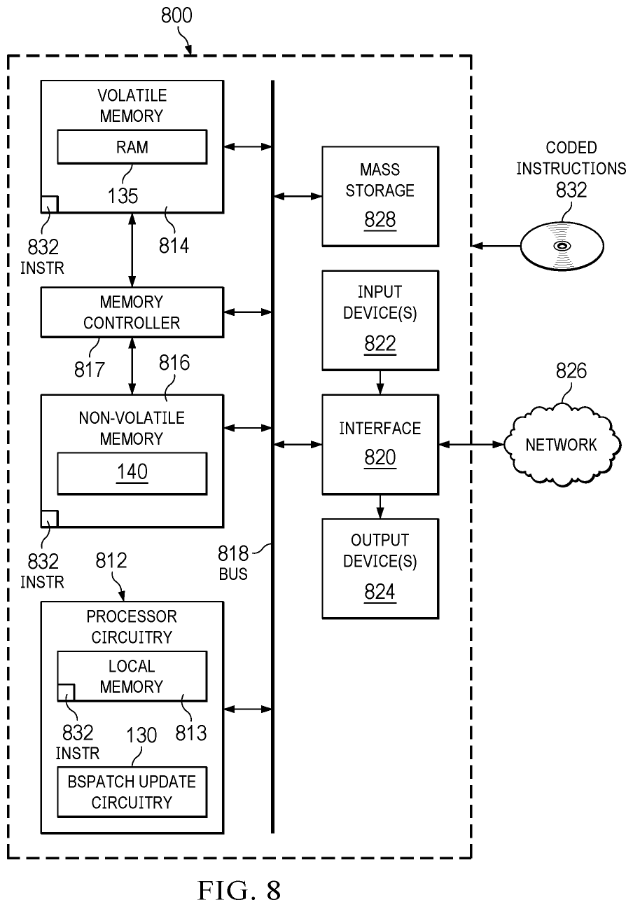

FIGS. 8A-8C form a flowchart representative of example machine-readable instructions and/or example operations that may be executed, instantiated, and/or performed using an example programmable circuitry implementation of the differential update controller circuitry of FIGS. 3-5.

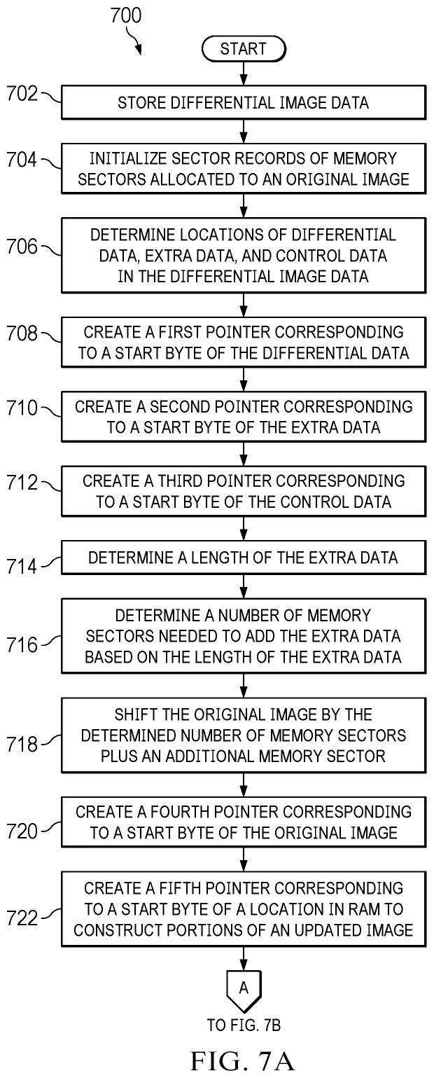

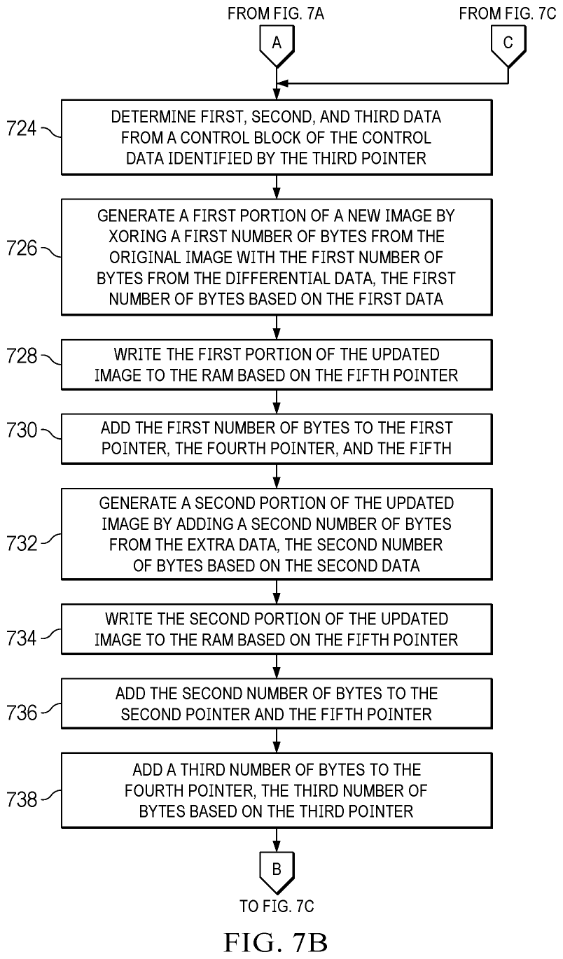

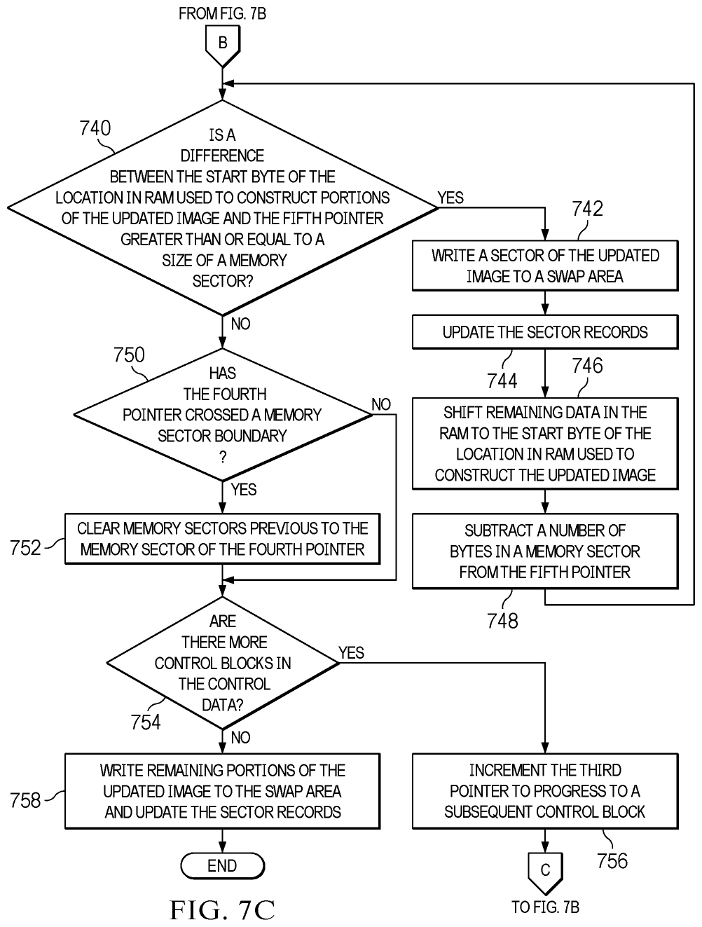

FIGS. 7A-7C are a flowchart representative of example machine-readable instructions and/or example operations 700 that may be executed, instantiated, and/or performed using an example programmable circuitry implementation of the differential update controller circuitry 360 of FIGS. 1, 3, and 4, and/or more generally the update circuitry 130 of FIGS. 1 and 2 to update the microprocessor circuitry 125 of FIG. 1. The example machine-readable instructions and/or example operations 700 of FIGS. 7A-7C begin at Block 702, at which the microprocessor circuitry 125 of FIG. 1 stores differential image data. In some examples, the differential circuitry 115 of FIG. 1 uses the update medium 120 of FIG. 1 to write differential image data to the flash memory 140 of FIGS. 1-5. In such examples, the differential circuitry 115 generates the differential image data using Bsdiff, described above, the original image 105 of FIGS. 1-5 and the updated image 110 of FIGS. 1-5.

The flash memory 140 initializes sector records of memory sectors allocated to an original image. (Block 704). In some examples, the flash memory 140 initializes the sector records 480 of FIG. 4 responsive to programmable circuitry executing instructions to instantiate the update circuitry 130. In such examples, the flash memory 140 sets the sector records 480 equal to a first value responsive to a determination that the microprocessor circuitry 125 is to update.

The differential data controller circuitry 310 of FIG. 3 determines locations of differential data, extra data, and control in the differential image data. (Block 706). In some examples, the differential data controller circuitry 310 determines memory addresses of the extra data 330 of FIGS. 3 and 4, the control data 340 of FIGS. 3 and 4, and the differential data 350 of FIGS. 3 and 4. In some such examples, the differential data controller circuitry 310 supplies the differential image data to the decompression circuitry 320 of FIG. 3 to decompress the extra data 330, the control data 340, and/or the differential data 350.

The tracking circuitry 400 of FIG. 4 creates a first pointer corresponding to a start byte of the differential data. (Block 708). In some examples, the tracking circuitry 400 initializes the differential pointer 404 of FIG. 4 to a memory address that corresponds to a start byte of the differential data 350.

The tracking circuitry 400 creates a second pointer corresponding to a start byte of the extra data. (Block 710). In some examples, the tracking circuitry 400 initializes the extra pointer 408 of FIG. 4 to a memory address that corresponds to a start byte of the extra data 330.

The tracking circuitry 400 creates a third pointer corresponding to a start byte of the control data. (Block 712). In some examples, the tracking circuitry 400 initializes the control pointer 412 of FIG. 4 to a memory address that corresponds to a start byte of the control data 340.

The sector shift circuitry 424 of FIG. 4 determines a length of the extra data. (Block 714). In some examples, the sector shift circuitry 424 determines a length of the extra data 330 using the extra pointer 408.

The sector shift circuitry 424 determines a number of memory sectors needed to add the extra data based on the length of the extra data. (Block 716). In some examples, the sector shift circuitry 424 divides the length of the extra data 330 by a size of a memory sector to determine the number of memory sectors needed to add the extra data 330.

The sector shift circuitry 424 shifts the original image by the determined number of memory sectors plus an additional memory sector. (Block 718). Although described as shifting one additional memory sector, the sector shift circuitry 424 may be configured to shift the original image by the determined number plus two or more additional memory sectors. In some examples, the sector shift circuitry 424 bit shifts the original image 105 in the fourth plurality of sectors 160 of FIGS. 1-5. In such examples, the sector shift circuitry 424 creates the swap area 476 of FIG. 4. Advantageously, creating the swap area 476 allows the differential update controller circuitry 360 to transfer portions of the update image 110 without writing over the original image 105.

The tracking circuitry 400 creates a fourth pointer corresponding to a start byte of the original image. (Block 720). In some examples, the tracking circuitry 400 initializes the original pointer 416 of FIG. 4 to a memory address that corresponds to a start byte of the original image 105 in the flash memory 140.

The tracking circuitry 400 creates a fifth pointer corresponding to a start byte of a location in RAM to construct portions of an updated image. (Block 722). In some examples, the tracking circuitry 400 initializes the RAM pointer 420 of FIG. 4 to a memory address in the RAM 135 of FIGS. 1, 3, and 4 corresponding to a location that the updated image 110 of FIGS. 1-5 is to be constructed.

Now turning to FIG. 7B, the controller circuitry 428 of FIG. 4 determines first, second, and third data from a control block of the control data identified by the third pointer. (Block 724). In some examples, the controller circuitry 428 reads a control block from the control data 340 based on the control pointer 412. In such examples, the controller circuitry 428 parses the control block into first data, second data, and third data.

The XOR circuitry 432 of FIG. 4 generates a first portion of the updated image by XORing a first number of bytes from the original image with the first number of bytes from the differential data, the first number of bytes based on the first data. (Block 726). In some examples, the XOR circuitry 432 determines the first number of bytes to XOR based on the first data from the controller circuitry 426. In such examples, the XOR circuitry 432 reads the first number of bytes from the original image 105 based on the original pointer 416 and the first number of bytes from the differential data 350 based on the differential pointer 404.

The XOR circuitry 432 writes the first portion of the updated image to the RAM based on the fifth pointer. (Block 728). In some examples, the XOR circuitry 432 writes the first portion of the updated image 110 resulting from the XOR operation to the RAM 135 based on a location specified by the RAM pointer 420.

The XOR circuitry 432 adds the first number of bytes to the first pointer, the second pointer, and the fifth pointer. (Block 730). In some examples, the XOR circuitry 432 increments the differential pointer 404, the original pointer 416, and the RAM pointer 420 by the number of bytes specified by the first data.

The RAM transfer circuitry 436 of FIG. 4 generates a second portion of the updated image by adding a second number of bytes from the extra data, the second number of bytes based on the second data. (Block 732). In some examples, the RAM transfer circuitry 436 determines the second number of bytes based on the second data from the controller circuitry 426. In such examples, the RAM transfer circuitry 436 reads the second number of bytes from the extra data 330 based on the extra pointer 408.

The RAM transfer circuitry 436 writes the second portion of the updated image to the RAM based on the fifth pointer. (Block 734). In some examples, the RAM transfer circuitry 436 writes the second portion of the updated image 110 to the RAM 135 based on a location specified by the RAM pointer 420.

The RAM transfer circuitry 436 adds the second number of bytes to the second pointer and the fifth pointer. (Block 736). In some examples, the RAM transfer circuitry 436 increments the extra pointer 408 and the RAM pointer 420 by the number of bytes specified by the second data.

The controller circuitry 428 adds a third number of bytes to the fourth pointer, the third number of bytes based on the third pointer. (Block 738). In such examples, the controller circuitry 428 disregards bytes of the original image 105 by incrementing the original pointer 416 by the number of bytes specified by the third data.

Now turning to FIG. 7C, the RAM pointer tracker circuitry 444 of FIG. 4 determines if a difference between the start byte of the location in RAM used to construct portions of the updated image and the fifth pointer greater than or equal to a size of a memory sector. (Block 740). In some examples, the RAM pointer tracker circuitry 444 determines if the portions of the updated image 110 constructed in the RAM 135 represent a sector of memory of the updated image 110. In such examples, the RAM pointer tracker circuitry 444 may determine a length of the portion of the updated image 110 in the RAM 135.

If the RAM pointer tracker circuitry 444 of FIG. 4 determines the difference between the start byte of the location in RAM used to construct portions of the updated image and the fifth pointer is greater than or equal to a size of a memory sector (e.g., Block 740 returns a result of YES), the flash transfer circuitry 452 of FIG. 4 writes a sector of the updated image to a swap area. (Block 742). In some examples, the flash transfer circuitry 452 reads a memory sector worth of the constructed portions of the updated image 110 from the RAM 135 and writes the memory sector worth of the updated image 110 to the swap area 476. In such examples, the flash transfer circuitry 452 determines a sector of memory of the swap area 476 to write to based on the sector records 480.

The flash transfer circuitry 452 updates the sector records. (Block 744). In some examples, the flash transfer circuitry 452 writes a second value to the record of the sector records 480 corresponding to the memory sector written to during Block 742. In such an example, the second value indicates that the memory sector contains a portion of the updated image 110.

The RAM update circuitry 456 of FIG. 4 shifts remaining data in the RAM to the start byte of the location in the RAM used to construct the updated image. (Block 746). In some examples, the RAM update circuitry 456 shifts data remaining in the RAM 135 following writing the portion of the updated image 110 by a number of bytes equal to the size of the memory sector (e.g., the memory sectors 210-250 of FIGS. 2 and 5).

The RAM update circuitry 456 subtracts a number of bytes in a memory sector from the fifth pointer. (Block 748). In some examples, the RAM update circuitry 456 subtracts the number of bytes equal to the size of the memory sector from the RAM pointer 420. The control proceeds to return to Block 740.

If the RAM pointer tracker circuitry 444 of FIG. 4 determines the difference between the start byte of the location in RAM used to construct portions of the updated image and the fifth pointer is not greater than or equal to a size of a memory sector (e.g., Block 740 returns a result of NO), the original pointer tracker circuitry 464 of FIG. 4 determines if the fourth pointer has crossed a memory sector boundary. (Block 750). In some examples, the original pointer tracker circuitry 464 monitors the original pointer 416 to determine when the memory address of the original pointer 416 increases to different memory sector.

If the original pointer tracker circuitry 464 determines if the fourth pointer has crossed a memory sector boundary (e.g., Block 750 returns a result of YES), the memory clear circuitry 472 of FIG. 4 clears memory sectors previous to the memory sector of the fourth pointer. (Block 752). In some examples, the memory clear circuitry 472 clears the memory sectors between the swap area 476 and the memory sector identified by the original pointer 416.

If the original pointer tracker circuitry 464 determines if the fourth pointer has not crossed a memory sector boundary (e.g., Block 750 returns a result of NO) or the operations of Block 752 occur, the controller circuitry 428 determines if there are more control block in the control data. (Block 754). In some examples, the controller circuitry 428 determines if there are additional control blocks based on the control pointer 412 and/or responsive to a reception of a final control block.

If the controller circuitry 428 determines if there are more control blocks in the control data (e.g., Block 754 returns a result of YES), the controller circuitry 428 increments the third pointer to progress to a subsequent control block. (Block 756). In some examples, the controller circuitry 428 increments the control pointer 412 to a subsequent control block of the control data 340. The control proceeds to return to Block 724.

If the controller circuitry 428 determines if there are no more control blocks in the control data (e.g., Block 754 returns a result of NO), the sector write circuitry 440 of FIG. 4 writes the remaining portions of the updated image to the swap area and updates the sector records. (Block 758). In some examples, the flash transfer circuitry 452 writes the remaining constructed portions of the updated image 110 in the RAM 135 to the swap area 476. In such examples, the RAM update circuitry 456 updates the sector records 480 to finalize the update process. The control proceeds to end.

Although example processes are described with reference to the flowchart illustrated in FIGS. 7A-7C, many other methods of updating microprocessor circuitry using differential image data may alternatively be used in accordance with teachings of this disclosure. For example, the order of execution of the blocks may be changed, and/or some of the blocks described may be changed, eliminated, or combined. Similarly, additional operations may be included in the manufacturing process before, in between, or after the blocks shown in the illustrated examples.

While an example manner of implementing the update circuitry 130 of FIG. 1 is illustrated in FIG. 3, one or more of the elements, processes, and/or devices illustrated in FIG. 3 may be combined, divided, re-arranged, omitted, eliminated, and/or implemented in any other way. Further, the differential data controller circuitry 310 of FIG. 3, the decompression circuitry 320 of FIG. 3, the differential update controller circuitry 360, and/or, more generally, the example update circuitry 130 of FIG. 3, may be implemented by hardware alone or by hardware in combination with software and/or firmware. Thus, for example, any of the differential data controller circuitry 310 of FIG. 3, the decompression circuitry 320 of FIG. 3, the differential update controller circuitry 360, and/or, more generally, the example update circuitry 130, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example update circuitry 130 of FIG. 3 may include one or more elements, processes, and/or devices in addition to, or instead of, those illustrated in FIG. 3, and/or may include more than one of any or all of the illustrated elements, processes, and devices.

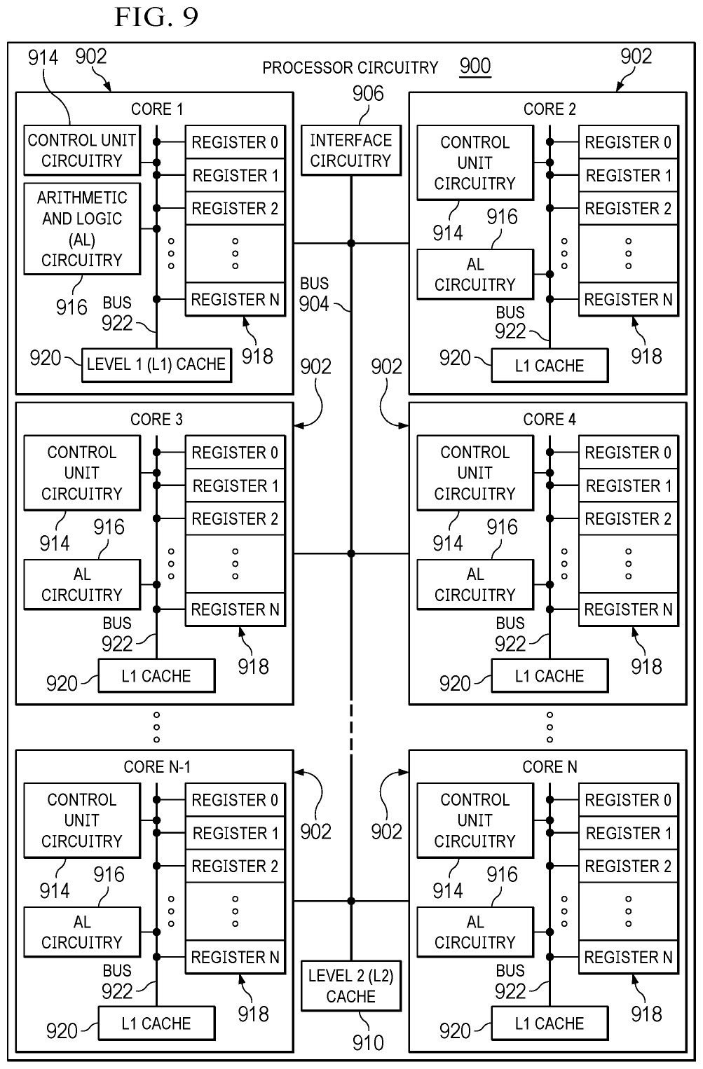

Flowchart(s) representative of example machine-readable instructions, which may be executed by programmable circuitry to implement and/or instantiate the update circuitry 130 of FIG. 3 and/or representative of example operations which may be performed by programmable circuitry to implement and/or instantiate the update circuitry 130 of FIG. 3, are shown in FIGS. 6, 7A, 7B, and/or 7C. The machine-readable instructions may be one or more executable programs or portion(s) of one or more executable programs for execution by programmable circuitry such as the programmable circuitry 812 shown in the example processor platform 800 described below in connection with FIG. 8 and/or may be one or more function(s) or portion(s) of functions to be performed by the example programmable circuitry (e.g., an FPGA) described below in connection with FIGS. 9 and/or 10. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6, 7A, 7B, and/or 7C, many other methods of implementing the example update circuitry may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6, 7A, 7B, and/or 7C may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C. (6) B with C, or (7) A with B and with C. As used herein in the context of describing structures, components, items, objects and/or things, the phrase “at least one of A and B” is intended to refer to implementations including any of (1) at least one A. (2) at least one B, or (3) at least one A and at least one B. Similarly, as used herein in the context of describing structures, components, items, objects and/or things, the phrase “at least one of A or B” is intended to refer to implementations including any of (1) at least one A. (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A. (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that objects. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a block diagram of an example programmable circuitry platform 800 structured to execute and/or instantiate the example machine-readable instructions and/or the example operations of FIGS. 6, 7A, 7B, and/or 7C to implement the update circuitry 130 of FIG. 3. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the differential data controller circuitry 310 of FIG. 3, the decompression circuitry 320 of FIG. 3, the differential update controller circuitry 360, and/or more generally the update circuitry 130 of FIGS. 1 and 3.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated examples is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 832, which may be implemented by the machine-readable instructions of FIGS. 6, 7A, 7B, and/or 7C, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 6, 7A, 7B, and/or 7C to effectively instantiate the circuitry of FIG. 2 as logic circuits to perform operations corresponding to those machine-readable instructions. In some such examples, the circuitry of FIG. 3 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine-readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine-readable instructions and/or operations represented by the flowcharts of FIGS. 6, 7A, 7B, and/or 7C.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer-based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those described herein. A GPU, DSP and/or other programmable device can also be an accelerator. Accelerators may be on-board the microprocessor 900, in the same chip package as the microprocessor 900 and/or in one or more separate packages from the microprocessor 900.

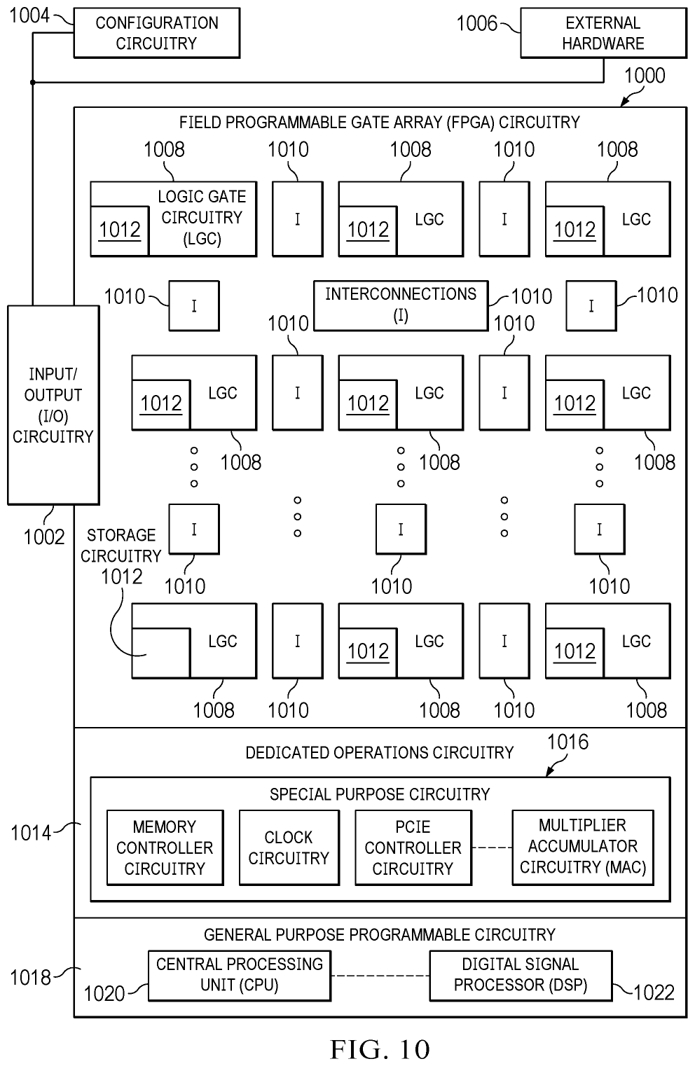

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine-readable instructions. However, once configured, the FPGA circuitry 1000 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine-readable instructions represented by the flowchart(s) of FIGS. 6, 7A, 7B, and/or 7C but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 6, 7A, 7B, and/or 7C. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6, 7A, 7B, and/or 7C. As such, the FPGA circuitry 1000 may be configured and/or structured to effectively instantiate some or all of the operations/functions corresponding to the machine-readable instructions of the flowchart(s) of FIGS. 6, 7A, 7B, and/or 7C as dedicated logic circuits to perform the operations/functions corresponding to those software instructions in a dedicated manner analogous to an ASIC. Therefore, the FPGA circuitry 1000 may perform the operations/functions corresponding to the some or all of the machine-readable instructions of FIGS. 6, 7A, 7B, and/or 7C faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High-Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine-readable instructions of FIGS. 6, 7A, 7B, and/or 7C and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine-readable instructions represented by the flowchart(s) of FIGS. 6, 7A, 7B, and/or 7C to perform first operation(s)/function(s), the FPGA circuitry 1000 of FIG. 10 may be configured and/or structured to perform second operation(s)/function(s) corresponding to a second portion of the machine-readable instructions represented by the flowcharts of FIGS. 6, 7A, 7B, and/or 7C, and/or an ASIC may be configured and/or structured to perform third operation(s)/function(s) corresponding to a third portion of the machine-readable instructions represented by the flowcharts of FIGS. 6, 7A, 7B, and/or 7C.

It should be understood that some or all of the circuitry of FIG. 3 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 900 of FIG. 9 may execute machine-readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 3 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

In this description, the term “and/or” (when used in a form such as A, B and/or C) refers to any combination or subset of A, B, C, such as: (a) A alone; (b) B alone; (c) C alone; (d) A with B; (c) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Numerical identifiers such as “first,” “second,” “third,” etc. are used merely to distinguish between elements of substantially the same type in terms of structure and/or function. These identifiers, as used in the detailed description, do not necessarily align with those used in the claims.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

Modifications are possible in the described embodiments, and other embodiments are possible, within the scope of the claims.

From the foregoing, it will be appreciated that example systems, apparatus, articles of manufacture, and methods have been described that enable microprocessor circuitry to update using differential image data. Described systems, apparatus, articles of manufacture, and methods improve the efficiency of using a computing device by allowing microprocessor circuitry to utilize Bsdiff to update using differential image data. Described systems, apparatus, articles of manufacture, and methods are accordingly directed to one or more improvement(s) in the operation of a machine such as a computer or other electronic and/or mechanical device.

1. An apparatus comprising:
interface circuitry;
machine-readable instructions; and
programmable circuitry configured to at least one of instantiate or execute the machine-readable instructions to:
determine a number of memory sectors to shift an original image based on a length of extra data in an updated image in differential image data;
shift the original image by the number of memory sectors to create a swap area, the swap area including the number of memory sectors; and
construct the updated image based on the differential image data and the original image.

2. The apparatus of claim 1, further comprising a first memory and a second memory, the first memory configured to store the original image and differential image data, the second memory configured to store one or more portions of the updated image.

3. The apparatus of claim 1, wherein the differential image data includes extra data, differential data, and control data, the control data including a plurality of control blocks, each control block of the plurality of control blocks having first data, second data, and third data, wherein the programmable circuitry is configured to:
determine the first data and the second data of a control block of the control data;
generate a first portion of the updated image by XORing a first number of bytes from the differential data with the first number of bytes from the original image, the first number of bytes based on the first data; and
generate a second portion of the updated image as a second number of bytes from the extra data, the second number of bytes based on the second data.

4. The apparatus of claim 3, wherein the programmable circuitry is configured to:
determine a length of the first portion of the updated image and the second portion of the updated image;
determine if the length is greater than or equal to a sector size, the sector size being a number of bytes in a sector of memory; and
write the number of bytes in a sector of memory of the first portion of the updated image and the second portion of the updated image responsive to determining the length is greater than or equal to a length of a sector of memory.

5. The apparatus of claim 1, wherein the programmable circuitry is configured to shift the swap area by clearing a sector of memory of the original image responsive to a determination that pointers to the sector of memory are no longer needed.

6. The apparatus of claim 1, wherein the programmable circuitry is configured to track the construction of the updated image using a plurality of records, the plurality of records includes a record for each sector of memory of the swap area and the original image, the record to identify one of a first value or a second value.

7. The apparatus of claim 1, wherein the programmable circuitry is configured to swap portions of the original image with the updated image based on the construction of portions of the updated image.

8. The apparatus of claim 1, wherein
the differential image data includes extra data that is to be added to the original image to construct the updated image; and
the differential image data includes differential data that represents a difference between bits of the original image and the updated image.

9. At least one non-transitory computer readable storage medium comprising instructions that, when executed, cause programmable circuitry to at least:
determine a number of memory sectors to shift an original image based on a length of extra data in an updated image in differential image data;
shift the original image by the number of memory sectors to create a swap area, the swap area including the number of memory sectors; and
construct the updated image based on the differential image data and the original image.

10. The at least one non-transitory computer readable storage medium of claim 9, further comprising a first memory and a second memory, the first memory configured to store the original image and differential image data, the second memory configured to store one or more portions of the updated image.

11. The at least one non-transitory computer readable storage medium of claim 9, wherein the differential image data includes extra data, differential data, and control data, the control data including a plurality of control blocks, each control block of the plurality of control blocks having first data, second data, and third data, wherein the instructions are to cause the programmable circuitry to:
determine the first data and the second data of a control block of the control data;
generate a first portion of the updated image by XORing a first number of bytes from the differential data with the first number of bytes from the original image, the first number of bytes based on the first data; and
generate a second portion of the updated image as a second number of bytes from the extra data, the second number of bytes based on the second data.

12. The at least one non-transitory computer readable storage medium of claim 11, wherein the instructions are to cause the programmable circuitry to:
determine a length of the first portion of the updated image and the second portion of the updated image;
determine if the length is greater than or equal to a sector size, the sector size being a number of bytes in a sector of memory; and
write the number of bytes in a sector of memory of the first portion of the updated image and the second portion of the updated image responsive to determining the length is greater than or equal to a length of a sector of memory.

13. The at least one non-transitory computer readable storage medium of claim 9, wherein the instructions are to cause the programmable circuitry to shift the swap area by clearing a sector of memory of the original image responsive to a determination that pointers to the sector of memory are no longer needed.

14. The at least one non-transitory computer readable storage medium of claim 9, wherein the instructions are to cause the programmable circuitry to track the construction of the updated image using a plurality of records, the plurality of records includes a record for each sector of memory of the swap area and the original image, the record to identify one of a first value or a second value.

15. The at least one non-transitory computer readable storage medium of claim 9, wherein the instructions are to cause the programmable circuitry to swap the original image with the updated image based on the construction of portions of the updated image.

16. The at least one non-transitory computer readable storage medium of claim 9, wherein:
the differential image data includes extra data that is to be added to the original image to construct the updated image; and
the differential image data includes differential data that represents a difference between bits of the original image and the updated image.

17. A method comprising:
determining a number of memory sectors to shift an original image based on a length of extra data in an updated image in differential image data;
shifting the original image by the number of memory sectors to create a swap area, the swap area including the number of memory sectors; and
constructing the updated image based on the differential image data and the original image.

18. The method of claim 17, wherein the differential image data includes extra data, differential data, and control data, the control data including a plurality of control blocks, each control block of the plurality of control blocks having first data, second data, and third data, further comprising:
determining the first data and the second data of a control block of the control data;
generating a first portion of the updated image by XORing a first number of bytes from the differential data with the first number of bytes from the original image, the first number of bytes based on the first data; and
generating a second portion of the updated image as a second number of bytes from the extra data, the second number of bytes based on the second data.

19. The method of claim 18, further comprising:
determining a length of the first portion of the updated image and the second portion of the updated image;
determining if the length is greater than or equal to a sector size, the sector size being a number of bytes in a sector of memory; and
writing the number of bytes in a sector of memory of the first portion of the updated image and the second portion of the updated image responsive to determining the length is greater than or equal to a length of a sector of memory.

20. The method of claim 17, further comprising shifting the swap area by clearing a sector of memory of the original image responsive to a determination that pointers to the sector of memory are no longer needed.
